(19) United States
(12) Patent Application Publication
(10) Pub. No.: US 2015/0372505 A1
(43) Pub. Date: Dec. 24, 2015

(54) POWER TRANSMISSION DEVICE AND POWER RECEPTION DEVICE

(71) Applicant: Murata Manufacturing Co., Ltd., Nagaokakyo-shi (JP)

(72) Inventor: Hironobu TAKAHASHI, Nagaokakyo-shi (JP)

(21) Appl. No.: 14/838,971

(22) Filed: Aug. 28, 2015

Related U.S. Application Data
(63) Continuation of application No. PCT/JP2013/082544, filed on Dec. 4, 2013.

(30) Foreign Application Priority Data
Mar. 1, 2013 (JP) 2013-040564

(51) Int. Cl. H02J 5/00; H02J 17/00

(52) U.S. Cl. CPC H02J 5/005; H02J 17/00

(57) ABSTRACT

A power transmission device includes a casing, an active electrode, a passive electrode, a first dielectric and a second dielectric. The casing forms an outer wall of the power transmission device. The active electrode is arranged inside the casing. The passive electrode is arranged close to the active electrode inside the casing. The first dielectric is arranged between the casing and the active electrode. The second dielectric is arranged between the casing and the passive electrode. A dielectric constant of the second dielectric is higher than a dielectric constant of the first dielectric. Thus, a capacitance is secured between the passive electrodes without making the surface areas of the passive electrodes excessively large.

### CROSS REFERENCE TO RELATED APPLICATIONS

The present application is a continuation of PCT/JP2013/082544 filed Dec. 4, 2013, which claims priority to Japanese Patent Application No. 2013-040564, filed Mar. 1, 2013, the entire contents of each of which are incorporated herein by reference.

The present invention relates to wireless power transmission systems in which power is transmitted using a non-contact method.

### BACKGROUND OF THE INVENTION

As a representative example of a wireless power transmission system, a magnetic-field-coupling-method power transmission system is known in which power is transmitted by utilizing a magnetic field from a primary coil of a power transmission device to a secondary coil of a power reception device. In this wireless power transmission system, when power is transmitted by magnetic field coupling, the magnitude of the magnetic flux passing through each coil greatly affects the electromotive force and therefore high accuracy is demanded in the relative positional relationship between the primary coil and the secondary coil. In addition, coils are utilized and therefore it difficult to reduce the size of the devices.

On the other hand, an electric-field-coupling-method wireless power transmission system is also known such as that disclosed in Patent Document 1. In this wireless power transmission system, power is transmitted via an electric field from a coupling electrode of a power transmission device to a coupling electrode of a power reception device. The accuracy of the relative positions of the coupling electrodes is less stringent in the electric field coupling method than in the magnetic field coupling method and it is possible to reduce the size and the thickness of the coupling electrodes.

Patent Document 1: International Publication No. 2011/148803 Pamphlet.

The coupling electrodes of an electric-field-coupling-method wireless power transmission system are formed of active electrodes and passive electrodes. In order to obtain a high power transmission efficiency in an electric-field-coupling-method wireless power transmission system, it is important to make an electric field coupling coefficient as high as possible. Consequently, it is effective to make the opposing surface area between the active electrode on the power transmission device side and the active electrode on the power reception device side large and to make the opposing surface area between the passive electrode on the power transmission device side and the passive electrode on the power reception device side large. In addition, making the thickness of an insulating layer on each electrode surface small is effective in order to make the space between the active electrodes and the space between the passive electrodes small in a state where the power reception device is contacting the power transmission device.

However, it is generally convenient that the potential of the passive electrode of the power reception device be a DC or AC reference potential of the power reception device. In such a case, it is necessary to stabilize the potential of the passive electrode of the power reception device in order to stabilize the reference potential of the power reception device. Consequently, it is a requirement that a capacitance generated between the passive electrode on the power transmission device side and the passive electrode on the power reception device side be larger than a capacitance generated between the active electrode on the power transmission device side and the active electrode on the power reception device side. In other words, the opposing surface area between the active electrodes is relatively small as a result of securing an opposing surface area between the passive electrode of the power transmission device and the passive electrode of the power reception device. Therefore, it is difficult to stabilize the reference potential of the power reception device while securing a high coupling coefficient with the limited opposing surface area between the power transmission device and the power reception device.

### SUMMARY OF THE INVENTION

Accordingly, in view of the above-described problem, an object of the present invention is to provide a power transmission device and a power reception device of a wireless power transmission system in which a capacitance can be secured between passive electrodes without making the surface areas of the passive electrodes excessively large.

A power transmission device of a wireless power transmission system according to the present invention includes a casing inside of which a power-transmission-side active electrode and a power-transmission-side passive electrode are arranged, a first dielectric arranged between the casing and the power-transmission-side active electrode, and a second dielectric arranged between the casing and the power-transmission-side passive electrode, a dielectric constant of the second dielectric being higher than a dielectric constant of the first dielectric.

With this configuration, an electrostatic capacity between the passive electrodes can be increased by the dielectric constant of the second dielectric. In other words, the electrostatic capacity between the passive electrodes can be increased without increasing the surface area of the passive electrodes. Therefore, a power transmission device having high power transmission efficiency despite being small-sized can be formed.

In addition, with this configuration, since the electrostatic capacity between the passive electrodes can be increased compared with the electrostatic capacity between the active electrodes, fluctuations in the voltage between the passive electrodes can be suppressed. Therefore, the potential of the passive electrode of the power transmission device can be stabilized.

A power reception device of a wireless power transmission system according to the present invention includes a casing inside of which a power-reception-side active electrode and a power-reception-side passive electrode are arranged, a first dielectric arranged between the casing and the power-reception-side active electrode, and a second dielectric arranged between the casing and the power-reception-side passive electrode, a dielectric constant of the second dielectric being higher than a dielectric constant of the first dielectric.

With this configuration, an electrostatic capacity between the passive electrodes can be increased by the dielectric constant of the second dielectric. In other words, the electrostatic capacity between the passive electrodes can be increased without increasing the surface area of the passive electrodes. Therefore, a power reception device having high power transmission efficiency despite being small-sized can be formed.

In addition, with this configuration, since the electrostatic capacity between the passive electrodes can be increased compared with the electrostatic capacity between the active electrodes, fluctuations in the voltage between the passive electrodes can be suppressed. Therefore, the potential of the passive electrode of the power reception device can be stabilized.

In the power transmission device or the power reception device according to the present invention, the electrostatic capacity between the passive electrodes can be increased without increasing the surface area of the passive electrodes.

### BRIEF DESCRIPTION OF THE DRAWINGS

FIG. 1 is an equivalent circuit diagram for a time when a power reception device according to a first embodiment of the present invention has been mounted on a power transmission device and there is capacitive coupling between passive electrodes of the two devices.

FIG. 2 illustrates a waveform of a voltage between active electrodes and a waveform of a voltage between passive electrodes of the two devices when the power reception device according to the first embodiment of the present invention has been mounted on the power transmission device.

FIG. 3 is a lateral sectional view illustrating the configurations of the power transmission device and the power reception device according to the first embodiment of the present invention.

FIG. 4 is a plan view illustrating the configuration of the power transmission device according to the first embodiment of the present invention.

FIG. 5 is a sectional view along A-A illustrating the configuration of the power transmission device according to the first embodiment of the present invention.

FIG. 6 is a plan view illustrating the configuration of the power reception device according to the first embodiment of the present invention.

FIG. 7 is a sectional view along B-B illustrating the configuration of the power reception device according to the first embodiment of the present invention.

FIG. 8 is a plan view illustrating another example configuration of the power transmission device according to the first embodiment of the present invention.

FIG. 9 is a plan view illustrating another example configuration of the power transmission device according to the first embodiment of the present invention.

FIG. 10 is a lateral sectional view illustrating the configurations of a power transmission device and a power reception device according to a second embodiment of the present invention.

FIG. 11 is a lateral sectional view illustrating the configurations of a power transmission device and a power reception device according to a third embodiment of the present invention.

### DETAILED DESCRIPTION OF THE EXEMPLARY EMBODIMENTS

Hereafter, wireless power transmission devices according to embodiments of the present invention will be described in detail while referring to the drawings.

First, a first embodiment of the present invention will be described.

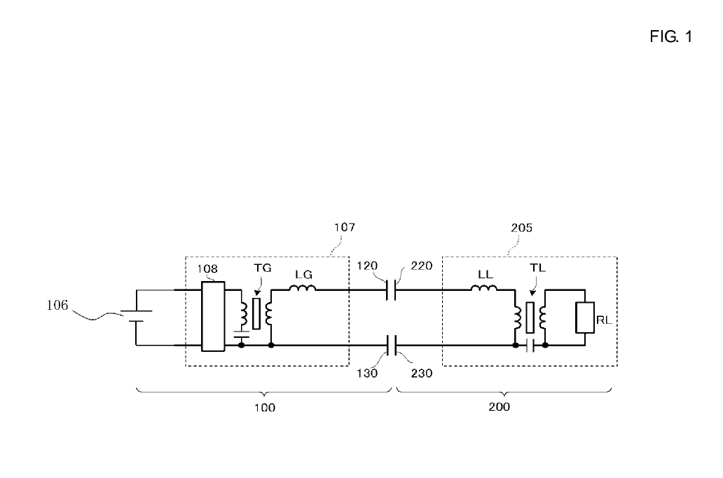

FIG. 1 is an equivalent circuit diagram for a time when a power reception device has been mounted on a power transmission device and there is capacitive coupling between passive electrodes of the two devices.

A power transmission device 100 includes an input power supply 106 and an alternating-current power generation circuit 107. The input power supply 106 is a direct-current voltage power supply of for example 5 V or 12 V converted from an alternating-current voltage of 100 to 230 V and outputs the voltage to the alternating-current power generation circuit 107. The alternating-current power generation circuit 107 is formed of for example an inverter 108, a step-up transformer TG and an inductor LG and applies a high-frequency high voltage between a power-transmission-side active electrode 120 and a power-transmission-side passive electrode 130. The frequency of this voltage is for example in the range of 100 kHz to 10 MHz.

A load circuit 205, which is composed of an inductor LL, a step-down transformer TL and a load RL, is connected between a power-reception-side active electrode 220 and a power-reception-side passive electrode 230 of a power reception device 200. The load RL is formed of a rectifying-smoothing circuit and a secondary battery, which are not illustrated.

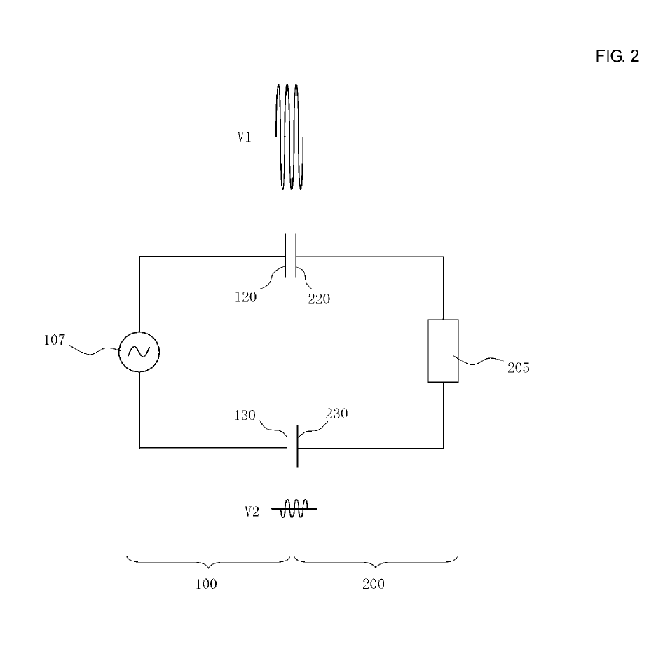

FIG. 2 illustrates a waveform of a voltage between the active electrodes and a waveform of a voltage between the passive electrodes of the two devices when the power reception device has been mounted on the power transmission device.

When the transmission-reception opposing surfaces of the power reception device 200 and the power transmission device 100 are made to oppose each other, capacitive coupling occurs between the active electrodes 120 and 220 and capacitive coupling occurs between the passive electrodes 130 and 230. Thus, a certain voltage V1 is applied between the active electrodes 120 and 220 and a certain voltage V2 is applied between the passive electrodes 130 and 230.

If charge passing through a capacitance (C1) generated between the active electrodes 120 and 220 is equal to charge passing through a capacitance (C2) generated between the passive electrodes 130 and 230 and is denoted by Q, Q=C1·V1=C2·V2. Therefore, if C1<C2, V1>V2.

In other words, if the capacitance between the passive electrodes 130 and 230 is made large compared with the capacitance between the active electrodes 120 and 220, the voltage V2 between the passive electrodes becomes small and fluctuations in the reference potential of the power reception device 200 (potential of passive electrode 230) become small.

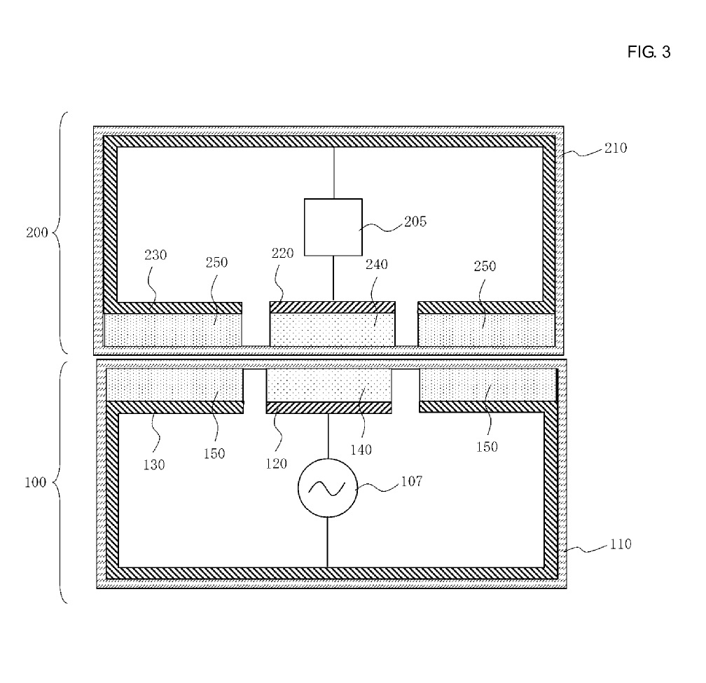

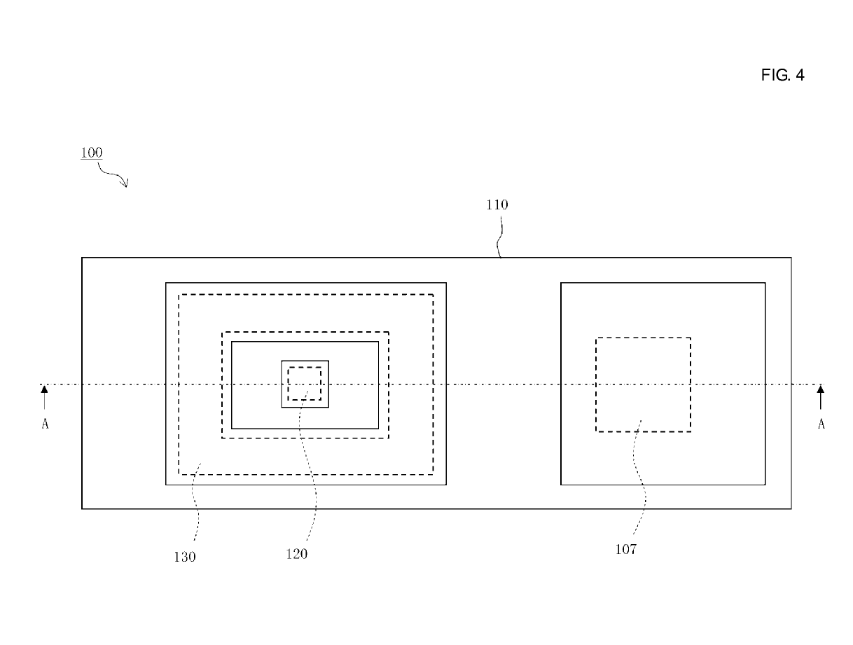

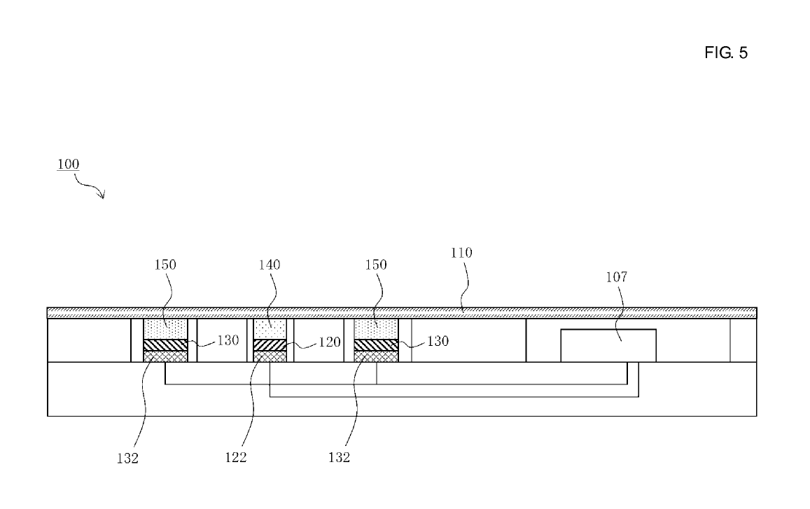

FIG. 3 is a lateral sectional view illustrating the configurations of the power transmission device and the power reception device. FIG. 4 is a plan view illustrating the configuration of the power transmission device. FIG. 5 is a sectional view along A-A illustrating the configuration of the power transmission device.

The power transmission device 100 includes a casing 110, the active electrode 120, the passive electrode 130, a first dielectric 140 and a second dielectric 150.

An upper surface of the casing 110 is formed in a flat-plate-like shape. The casing 110 is formed of a highly rigid material such as a polycarbonate resin or a high-rigidity-grade ABS.

The active electrode 120 is arranged inside the casing 110. The active electrode 120 has a rectangular shape when viewed in plan. The active electrode 120 is formed of a metal body such as copper or aluminum. The active electrode 120 is fixed inside the casing 110 with an adhesive 122. The active electrode 120 and the passive electrode 130 are electrically connected to the alternating-current power generation circuit 107.

The passive electrode 130 is arranged close to the active electrode 120 inside the casing 110. Specifically, the passive electrode 130 is arranged so as to be separated from the active electrode 120 by a certain distance and so as to surround the active electrode 120 when viewed in plan. The passive electrode 130 is formed of a metal body such as copper or aluminum. The passive electrode 130 is fixed inside the casing 110 with an adhesive 132.

The first dielectric 140 is arranged between the casing 110 and the active electrode 120. The first dielectric 140 is fixed to the casing 110 with an adhesive for example. The first dielectric 140 is formed of an insulator such as a ceramic. The dielectric constant of the first dielectric 140 is less than 100. In the case where the capacitance per unit surface area of the capacitance generated between the active electrodes 120 and 220 is on the order of 0.046 pF/mm² for example and all of a 900 mm² surface area of the active electrode 120 opposes the active electrode 220, the capacitance generated between the active electrodes 120 and 220 is on the order of 41 pF.

The second dielectric 150 is arranged between the casing 110 and the passive electrode 130. The second dielectric 150 is fixed to the casing 110 with an adhesive for example. The second dielectric 150 is formed of a material having a higher dielectric constant than the first dielectric 140. It is preferable that the dielectric constant of the second dielectric 150 be at least 100 times the dielectric constant of the first dielectric 140. In the case where the capacitance per unit surface area of the capacitance generated between the passive electrodes 130 and 230 is on the order of 6.67 pF/mm² for example and all of a 5414 mm² surface area of the passive electrode 130 opposes the passive electrode 230, the capacitance generated between the passive electrodes 130 and 230 is on the order of 3.6 nF.

With this configuration, the capacitance between the passive electrodes 130 and 230 can be increased by the dielectric constant of the second dielectric 150. In other words, the electrostatic capacity between the passive electrodes 130 and 230 can be increased without increasing the surface area of the passive electrode 130. Therefore, it is possible suppress an increase in the size of the power transmission device 100 and the power reception device 200.

Furthermore, with this configuration, since the capacitance between the passive electrodes 130 and 230 is made large compared with the capacitance between the active electrodes 120 and 220, the voltage acting between the passive electrodes 130 and 230 becomes small. Therefore, the potential of the passive electrodes 130 and 230 can be stabilized.

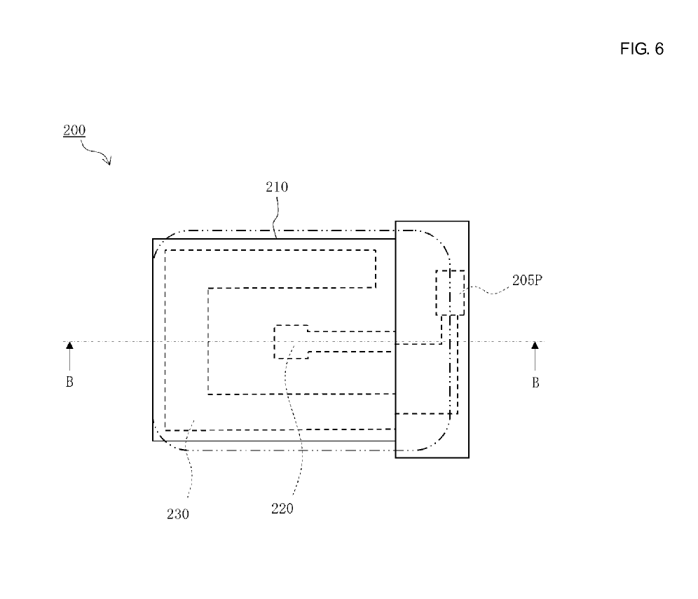

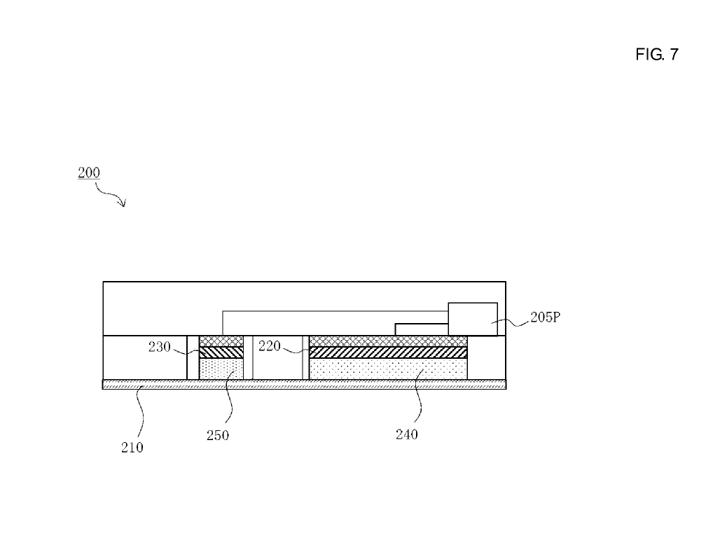

FIG. 6 is a plan view illustrating the configuration of the power reception device. FIG. 7 is a sectional view along B-B illustrating the configuration of the power reception device.

The power reception device 200 includes a casing 210, the active electrode 220, the passive electrode 230, a first dielectric 240 and a second dielectric 250. The power reception device 200 is used by being installed in an electronic appliance such as a cellular phone, a tablet PC or a notebook PC.

A lower surface of the casing 210 is formed in a flat-plate-like shape. The casing 210 is formed of a material having high rigidity. The casing 210 is formed of a polycarbonate resin or a high-rigidity-grade ABS for example.

The active electrode 220 is arranged inside the casing 210. The active electrode 220 has a rectangular shape when viewed in plan. The active electrode 220 is formed of a metal body such as copper or aluminum. The active electrode 220 is fixed inside the casing 210 with an adhesive for example. A part 205P of the load circuit 205 is connected to the active electrode 220 and the passive electrode 230. The part 205P of the load circuit is a portion of the load circuit 205 illustrated in FIG. 1 other than the load RL and includes a plug or receptacle to be inserted into a connector of a tablet PC.

The passive electrode 230 is arranged close to the active electrode 220 inside the casing 210. Specifically, the passive electrode 230 is arranged so as to be separated from the active electrode 220 by a certain distance and so as to surround the active electrode 220 when viewed in plan. The passive electrode 230 is formed of a metal member such as copper or aluminum. The passive electrode 230 is fixed inside the casing 210 with an adhesive for example.

The first dielectric 240 is arranged between the casing 210 and the active electrode 220. The first dielectric 240 is fixed to the casing 210 with an adhesive for example. The first dielectric 240 is formed of an insulator such as a ceramic. The dielectric constant of the first dielectric 240 is less than 100.

The second dielectric 250 is arranged between the casing 210 and the passive electrode 230. The second dielectric 250 is fixed to the casing 210 with an adhesive for example. The second dielectric 250 is formed of a material having a higher dielectric constant than the first dielectric 240. It is preferable that the dielectric constant of the second dielectric 250 be at least 100 times the dielectric constant of the first dielectric 240.

With this configuration, the capacitance between the passive electrodes 230 and 130 can be increased by the dielectric constant of the second dielectric 250. In other words, the capacitance between the passive electrodes 230 and 130 can be increased without increasing the surface area of the passive electrode 230. Therefore, it is possible to suppress an increase in the size of the power reception device 200.

Furthermore, with this configuration, since the capacitance between the passive electrodes 230 and 130 is increased compared with the capacitance between the active electrodes 220 and 120, the voltage acting between the passive electrodes 230 and 130 becomes small. Therefore, the potential between the passive electrodes 230 and 130 can be stabilized.

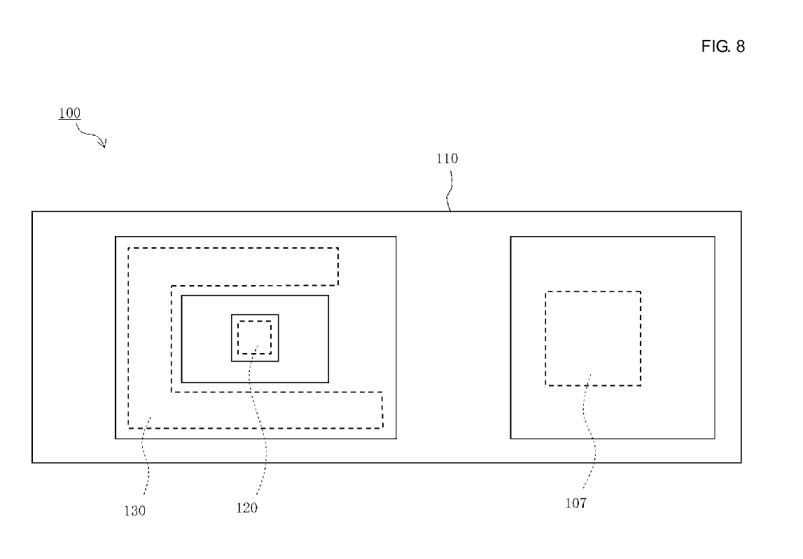

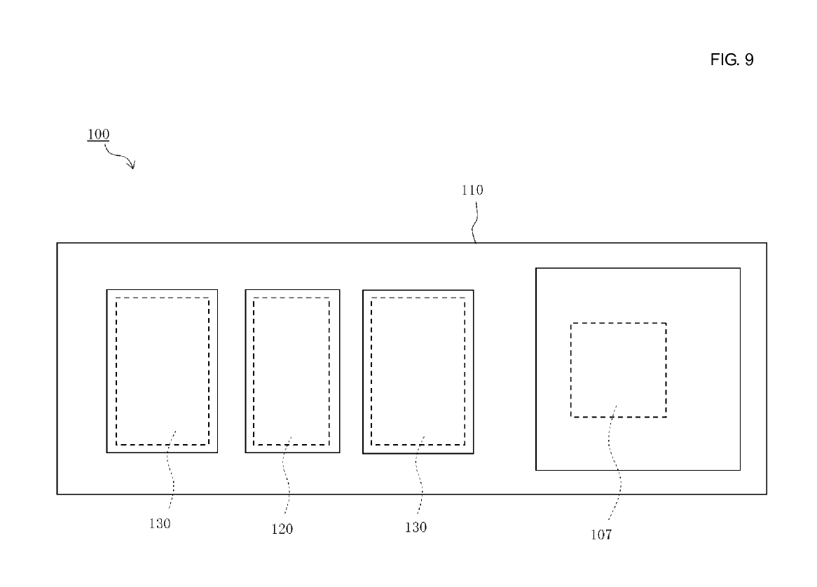

FIG. 8 and FIG. 9 are plan views illustrating other example configurations of the power transmission device.

The passive electrode 130 need not completely surround the active electrode 120 when viewed in plan. In addition, passive electrodes 130 may be arranged so as to oppose each other with an active electrode 120 interposed therebetween when viewed in plan. Thus, the arrangement of the active electrode 120 and the passive electrode 130 is not particularly limited.

In addition, it is preferable that the thickness of the second dielectric 150 be the same as the thickness of the first dielectric 140.

With this configuration, the manufacture of the power transmission device 100 is simple and a reduction in cost can be achieved for the power transmission device 100 as a whole.

In addition, it is preferable that the thickness of the second dielectric 250 be the same as the thickness of the first dielectric 240.

With this configuration, the manufacture of the power reception device 200 is simple and a reduction in cost can be achieved for the power reception device 200 as a whole.

Next, a second embodiment of the present invention will be described. In each of the following embodiments, content described in the first embodiment is appropriately omitted.

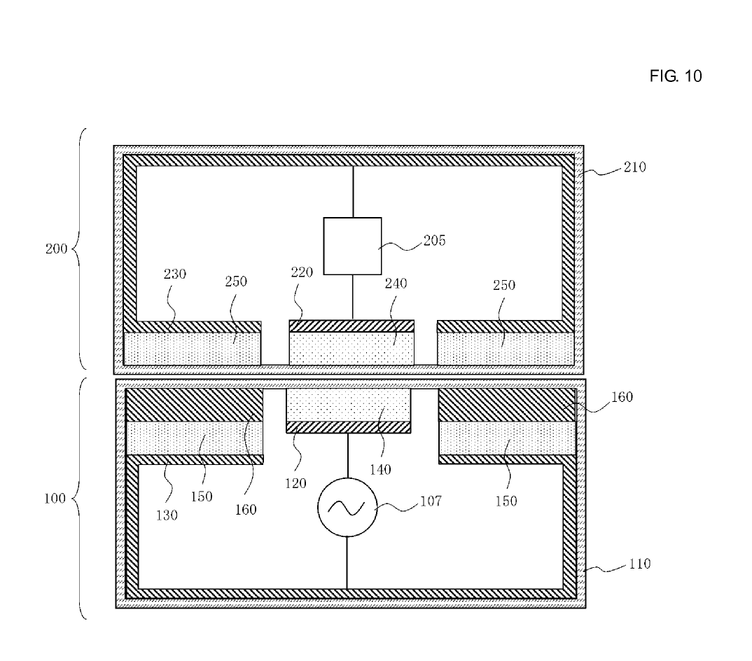

FIG. 10 is a lateral sectional view illustrating the configurations of a power transmission device and a power reception device.

In addition to the configuration of the first embodiment, the power transmission device 100 further includes conductive rubber 160 arranged between the casing 110 and the second dielectric 150. The conductive rubber 160 corresponds to a conductor of the present invention.

With this configuration, since the conductive rubber 160 is arranged between the casing 110 and the passive electrode 130, a distance is secured between the casing 110 and the passive electrode 130. In other words, a distance is secured between the passive electrode 130 and the passive electrode 230. Therefore, it is possible to suppress generation of an electrical discharge between the passive electrode 130 and the passive electrode 230.

In addition, with this configuration, since the conductive rubber 160 has a certain degree of conductivity, the conductive rubber 160 can be thought of as being part of the passive electrode 130 when considered as an element having electrostatic capacity. That is, an inter-electrode distance between the passive electrode 130 and the passive electrode 230 is merely the sum of the thicknesses of the casings 110 and 210 and the thicknesses of the second dielectrics 150 and 250 and therefore an inter-electrode distance that causes an electrostatic capacity to be generated is substantially shortened. Therefore, a large electrostatic capacity can be generated between the passive electrode 130 and the passive electrode 230 and therefore a certain capacitance can be obtained between the passive electrodes 130 and 230 while suppressing generation of an electrical discharge.

In addition, although the conductive rubber 160 is arranged between the casing 110 and the second dielectric 150 in the above description, the conductive rubber 160 may be arranged between the casing 110 and the first dielectric 140.

It is preferable that the conductive rubber 160 be formed of a material that is softer than the second dielectric 150. As a result, the conductive rubber 160 functions as a cushioning member and therefore the conductive rubber 160 is able to protect the second dielectric 150 by absorbing impacts against the second dielectric 150.

Next, a third embodiment of the present invention will be described.

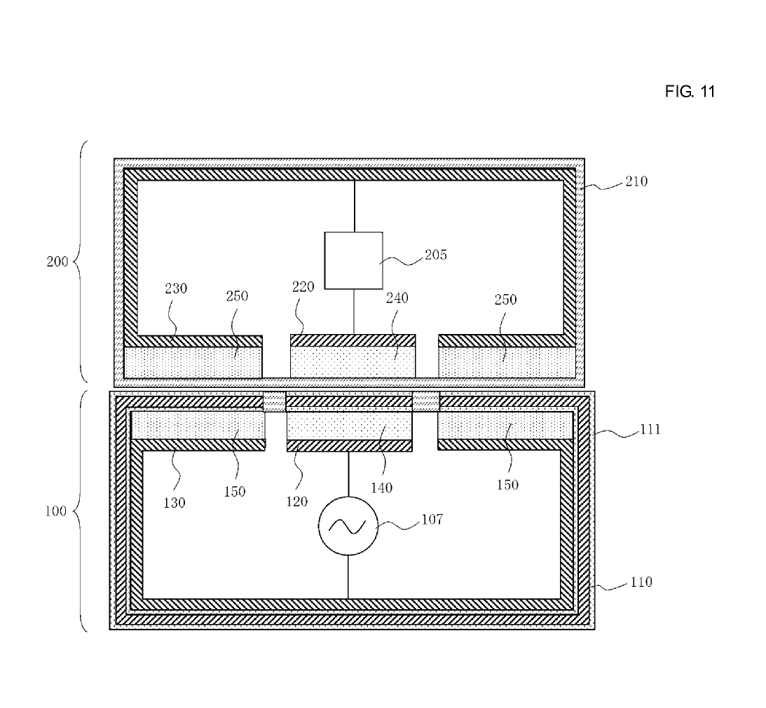

FIG. 11 is a lateral sectional view illustrating the configurations of a power transmission device and a power reception device.

The casing 110 is formed of a metal material. An outer surface of the casing 110 is covered by a metallic oxide. An insulating film is formed by subjecting a surface of an aluminum substrate to an oxidation treatment (alumite treatment) for example. With this configuration, the thickness of the metallic oxide is on the order of 20 μm to 30 μm for example.

In addition, although an outer surface of the casing 110 is covered by a metallic oxide in the above description, an outer surface of the casing 210 may be covered by a metallic oxide.

Finally, the descriptions of the above embodiments should be thought of as being illustrative in all points and not restrictive. The scope of the present invention is to be shown by the following claims rather than by the above-described embodiments. In addition, it is intended that equivalents to the scope of the claims and all modifications that are within the scope of the claims be included within the scope of the present invention.

### REFERENCE SIGNS LIST

100—power transmission device
110—casing
120—active electrode
130—passive electrode
140—first dielectric
150—second dielectric
160—conductive rubber (conductor)
200—power reception device
210—casing
220—active electrode
230—passive electrode
240—first dielectric
250—second dielectric

1. A power transmission device for providing power to a power reception device, the power transmission device comprising:
a casing;
an active electrode and a passive electrode each disposed inside the casing;
a first dielectric disposed between the casing and the active electrode; and
a second dielectric disposed between the casing and the passive electrode,
wherein a dielectric constant of the second dielectric is higher than a dielectric constant of the first dielectric.

2. The power transmission device according to claim 1, wherein the active electrode and the passive electrode each extend along a transmission/reception opposition surface of the casing.

3. The power transmission device according to claim 2, wherein a distance between the transmission/reception opposition surface and the passive electrode is larger than a distance between the transmission/reception opposition surface and the active electrode.

4. The power transmission device according to claim 1, further comprising an alternating-current power generation circuit having a first end connected to the active electrode and a second end connected to the passive electrode.

5. The power transmission device according to claim 1, wherein a thickness of the second dielectric is the same as a thickness of the first dielectric.

6. The power transmission device according to claim 5, where the active electrode and at least a portion of the passive electrode each comprise a planar shape in a same plane when viewed in a plan view of the power transmission device.

7. The power transmission device according to claim 1, further comprising a conductor disposed between the casing and one of the first dielectric and the second dielectric.

8. The power transmission device according to claim 7, wherein the conductor is a conductive rubber.

9. The power transmission device according to claim 8, wherein the conductive rubber is disposed between the casing and the second dielectric and comprises a material softer than the second dielectric.

10. The power transmission device according to claim 1, wherein the passive electrode completely surrounds the active electrode with a space therebetween when viewed in a plan view of the power transmission device.

11. The power transmission device according to claim 1, wherein the casing comprises a metal material and an outer surface of the casing is covered by a metallic oxide.

12. A power reception device configured to wirelessly receive power from a power transmission device, the power reception device comprising:
a casing;
an active electrode and a passive electrode disposed inside the casing;
a first dielectric disposed between the casing and the active electrode; and
a second dielectric disposed between the casing and the passive electrode;
wherein a dielectric constant of the second dielectric is higher than a dielectric constant of the first dielectric.

13. The power reception device according to claim 12, wherein the casing comprises a metal material and an outer surface of the casing is covered by a metallic oxide.

14. The power reception device according to claim 12, wherein the active electrode and the passive electrode each extend along a transmission/reception opposition surface of the casing.

15. The power reception device according to claim 12, further comprising a load circuit having a first end connected to the active electrode and a second end connected to the passive electrode.

16. The power reception device according to claim 12, wherein a thickness of the second dielectric is the same as a thickness of the first dielectric.

17. The power reception device according to claim 16, where the active electrode and at least a portion of the passive electrode each comprise a planar shape in a same plane when viewed in a plan view of the power transmission device.

18. The power reception device according to claim 12, wherein the passive electrode completely surrounds the active electrode with a space therebetween when viewed in a plan view of the power transmission device.
